(19) United States
(12) Patent Application Publication
(10) Pub. No.: US 2009/0109572 A1
(43) Pub. Date: Apr. 30, 2009

(54) HEAD SLIDER, HEAD GIMBAL ASSEMBLY and STORAGE APPARATUS

(75) Inventor: Toru Watanabe, Kawasaki (JP)

Correspondence Address: GREER, BURNS & CRAIN, 300 S WACKER DR, 25TH FLOOR, CHICAGO, IL, 60606, US

(73) Assignee: FUJITSU LIMITED, Kawasaki-shi (JP)

(21) Appl. No.: 12/209,868

(22) Filed: Sep. 12, 2008

(30) Foreign Application Priority Data
Oct. 31, 2007 (JP) 2007-283646

(51) Int. Cl. G11B 5/60

(52) U.S. Cl. 360/235.4

(57) ABSTRACT

A head slider includes a leading end and a trailing end, a main top face and two step faces. The main top face faces a recording medium and forms a part of the leading end. The two step faces extend from the leading end to a downstream side at a lower position than the main top face when the main top face is placed face up. The step faces are respectively provided at the right and left sides with respect to the airflow. The main top face extends between the two step faces. The other portion of the main top face extends at the rear side of the step faces. At least a part of the head slider floats above the recording medium.

### CROSS-REFERENCE TO RELATED APPLICATION

This application is based upon and claims the benefit of priority of the prior Japanese Patent Application No. 2007-283646, filed on Oct. 31, 2007, the entire contents of which are incorporated herein by reference.

### BACKGROUND

1. Field

An aspect of the invention is related to a head slider which may include head sliders used for a storage apparatus.

2. Description of the Related Art

For example, in a magnetic disk driving apparatus such as a hard disk drive (HDD) or the like, the whole or a part of a head slider is generally floated above a magnetic disk by airflow which is generated by rotation of the magnetic disk. A load/unload mechanism for supporting a suspension, which in turn supports the head slider, is used when the magnetic disk is in a stationary state. By the load/unload mechanism, the head slider is protected from contact with the magnetic disk when the magnetic disk is in the stationary state.

The load/unload mechanism has a ramp disposed in the neighborhood of the magnetic disk. The tip of the suspension runs on the ramp while coming into sliding contact with the ramp. The head slider is evacuated from the magnetic disk as described above. The operation as described above is referred to as the unload operation or unload condition. On the other hand, the load operation occurs when the head slider is disposed above the magnetic disk. Normally, the load and unload operations are carried out while the magnetic disk is rotated.

In the load operation, there is a risk that the head slider comes into contact with the magnetic disk. When the head slider comes into contact with the magnetic disk, the magnetic disk is damaged, and recording information on the magnetic disk may be lost. Furthermore, dust occurs due to abrasion, scratch or the like which is caused by the contact.

In a recent magnetic disk device, the gap between the head slider and the magnetic disk is reduced to about 10 nm in order to enhance the recording density. When dust occurs as described above, the gap of about 10 nm cannot be kept. At this time, the head slider may come into contact with the magnetic disk out of an load area of the magnetic disk and thus damage the magnetic disk. In such a case, the reliability of the magnetic disk is greatly reduced or lost.

The head slider is designed so that it does not come into contact with the magnetic disk under the loading operation as much as possible. For example, Japanese Laid-open Patent Publication No. 2001-344724 discloses a structure in which a base face is provided to the flow-in front edge portion of a head slider and a step face and a top face are provided at the downstream side of the base face. The channel of the gap between the magnetic disk and the head slider becomes more narrow as it goes to the downstream side, so that the pressure occurring at the top face can be increased. Great force which keeps the head slider spaced from the magnetic disk can be generated at the air flow-in side of the head slider. The contact between the air flow-in side portion of the head slider and the magnetic disk, which is particularly problematic during the load operation, can be suppressed.

Furthermore, Japanese Laid-open Patent Publication No. 2004-71140 discloses a structure in which a shallow recess portion is provided in the neighborhood of the air flow-in front edge portion of a head slider. Positive pressure is generated by airflow flowing from the recess portion to the top face. The lifting force at the air flow-in front edge portion of the head slider can be enhanced by this pressure.

In the structure disclosed in Japanese Laid-open Patent Publication No. 2001-344724, the pressure occurring at the air flow-in side is increased, and thus the gap between the air flow-in side portion of the head slider and the magnetic disk is increased. There is a risk that dust will invade the gap between the head slider and the magnetic disk from the air flow-in side of the head slider. The dust invading into the gap between the head slider and the magnetic disk may scratch the magnetic disk or damage the magnetic head. Accordingly, it is necessary that the gap between the head slider and the magnetic disk at the air flow-in side be reduced to the minimum value. However, when the step of the air flow-in side front edge portion is reduced to lower the pressure at the air flow-in side of the head slider, the pressure occurring during the load operation is also reduced. The air flow-in side of the head slider is liable to come into contact with the magnetic disk. Accordingly, there is needed a head slider that better avoids contact with a magnetic disk during a load operation, and in which the gap of the air flow-in side can be reduced.

Furthermore, in the construction disclosed in Japanese Laid-open Patent Publication No. 2001-344724, the top face is narrowed because the recess portion is formed. Therefore, there is a risk that positive pressure at the center portion of the head slider occurring due to airflow flowing along the top face cannot be sufficiently generated.

### SUMMARY

Accordingly, it is an object of the embodiments to provide a head slider that substantially avoids contact with a magnetic disk during a load operation and in which dust hardly invades from an air flow-in side under a normal use state.

According to an aspect of the invention, a head slider includes a leading end and a trailing end of airflow occurring in connection with movement of a moving recording medium. The head slider also has a main top face and two step faces. The main top face is configured to face the recording medium and forms a part of the leading end. The two step faces extend from the leading end to a downstream side at a lower position than the main top face when the main top face is placed face up. The step faces are respectively provided at the right and left sides with respect to the airflow. Part of the main top face is provided so as to extend between the two step faces. The other portion of the main top face is provided so as to extend at the rear side of the step faces. At least a part of the head slider is floated above the recording medium.

Additional objects and advantages of the invention will be set forth in part in the description which follows, and in part will be obvious from the description, or may be learned by practice of the invention. The object and advantages of the invention will be realized and attained by means of the elements and combinations particularly pointed out in the appended claims.

It is to be understood that both the foregoing general description and the following detailed description are exemplary and explanatory only and are not restrictive of the invention, as claimed.

### BRIEF DESCRIPTION OF DRAWINGS

The present invention will be explained with reference to the accompanying drawings.

FIG. 1 is a plan view schematically showing the inside of a hard disk-drive.

FIG. 2 is an enlarged plan view of the neighborhood of a head slider in the hard disk drive of FIG. 1.

FIG. 3 is a perspective view showing the head slider according to a first embodiment of the present invention.

FIG. 4 is a graph showing the relationship between the depth of a step face and occurring positive pressure.

FIG. 5 is a perspective view showing a head slider according to a modification of the head slider shown in FIG. 3.

FIG. 6 is a graph showing the relationship between the depth of a negative pressure occurring face and the negative pressure.

FIG. 7 is a diagram showing a computer simulation result of a pressure distribution in the head slider shown in FIG. 5.

FIG. 8 is a perspective view showing a head slider according to a second embodiment of the present invention.

FIG. 9 is a perspective view showing a head slider according to a modification of the head slider shown in FIG. 8.

FIG. 10 is a diagram showing a computer simulation result of a pressure distribution in the head slider shown in FIG. 9.

FIG. 11 is a perspective view showing of a head slider according to a third embodiment of the present invention.

FIG. 12 is a perspective view showing a head slider according to a modification of the head slider shown in FIG. 11.

FIG. 13 is a computer simulation result of a pressure distribution in the head slider shown in FIG. 12.

### DETAILED DESCRIPTION OF THE PREFERRED EMBODIMENTS

Embodiments of the present invention will be described in detail below with reference to the accompanying drawings.

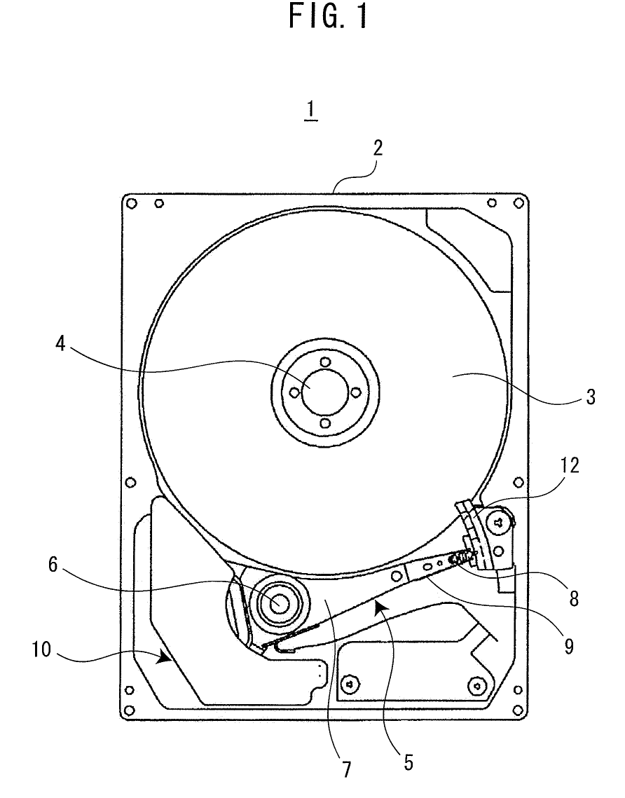

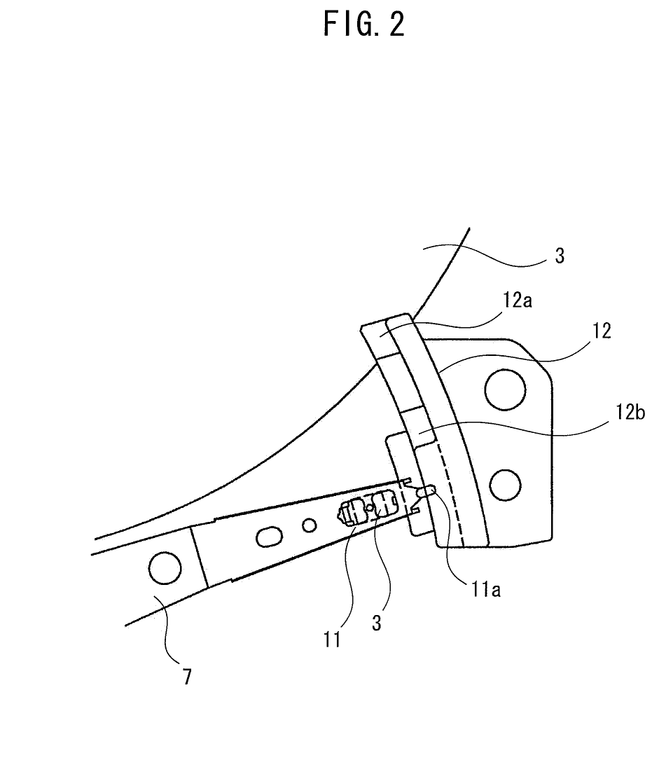

First, a hard disk drive having a magnetic head slider as an example of a head slider to which the present invention is applied will be described with reference to FIGS. 1 and 2. FIG. 1 is a plan view showing the inside of the hard disk drive as a recording medium driving device. FIG. 2 is an enlarged plan view of the neighborhood of the head slider of FIG. 1.

The hard disk drive 1 has a box-shaped housing main body 2 of a flat rectangular parallelepiped, the inner space of the housing main body 2 being compartmented. One or more magnetic disks 3 are accommodated as recording media in the housing main body 2. The magnetic disk 3 is mounted on the rotating shaft of a spindle motor 4. The spindle motor 4 can rotate the magnetic disk 3 at high speed such as 7200 rpm or 10000 rpm, for example. A lid, that is, a cover (not shown) which hermetically seals the inner space together with the housing main body 2 is joined to the housing main body 2.

A carriage 5 is provided in the inner space of the housing main body 2 so that the tip thereof faces the surface of the magnetic disk 3. The carriage 5 is equipped with a swing arm 7 which swings around a support shaft 6, and a head suspension 9 which is fixed to the tip of the swing arm 7 and individually supports the head slider 8 at the tip thereof. The swing motion of the swing arm 7 is implemented through the action of an electromagnetic actuator 10 such as a voice coil motor (VCM), for example. According to the swing motion of the swing arm 7, the head slider 8 can traverses the magnetic disk 3 in the radial direction. By this movement, the head slider 8 is positioned to a desired recording track on the magnetic disk 3. As well known, when plural magnetic disks are loaded in the housing main body 2, two head sliders 8 and head suspensions 9 are mounted on one swing arm 7 between the neighboring magnetic disks 3.

A load beam 11 extending from the head suspension 9 to the front side is secured to the tip of the head suspension 9 of the carriage 5. The load beam 11 moves in the radial direction of the magnetic disk 3 together with the head slider 8 in connection with the swing motion of the swing arm 7.

A ramp member 12 is disposed around the magnetic disk 3 at a position along the movement path of the load beam 11. The tip portion 11a of the load beam 11 runs on an inclined plane 12a of the ramp member 12 when the head slider 8 moves to the outer peripheral portion of the magnetic disk 3. When the load beam 11 further moves so as to be far away from the magnetic disk, the tip portion 11a of the load beam 11 moves while coming into sliding contact with the inclined plane 12a. At this time, the load beam 11 is gradually lifted up along the inclined plane 12a, so that the head slider 8 is far away from the magnetic disk 3. When the tip portion 11a of the load beam 11 has perfectly ascended over the inclined plane 12a and then intrudes into the recess portion 12b, the movement of the load beam 11 inwardly with respect to the radial direction is stopped. This is referred to as an unload operation. As described above, the head slider 8 is kept under the non-contact state with the magnetic disk 3 when the magnetic disk is stationary. When the head slider 8 is moved to a position above the magnetic disk 3, the load beam 11 moves inwardly with respect to the radial direction of the magnetic disk 3. Accordingly, the tip portion 11a of the load beam 11 descends along the inclined plane 12a. Finally, the tip portion 11a of the load beam 11 is separated from the inclined plane 12a, and the head slider 8 is disposed above the magnetic disk 3. This is referred to as a load operation. At this time, the magnetic disk 3 has been already started rotating at high speed, and thus the head slider 8 is floated above the magnetic disk 3 by airflow caused by the rotation of the magnetic disk 3. As described above, the load beam 11 and the ramp member 12 constitute the load/unload mechanism in cooperation with each other.

During the load operation (when the head slider 8 is floated above the magnetic disk 3), it is preferable that the head slider 8 be moved to a position above the magnetic disk 3 while slightly inclined so that the air flow-in side is placed face up. Therefore, the securing portion of the head slider 8 is designed so as to be slightly inclined so that the air flow-in side is placed face up when the head slider 8 is freely supported. However, in some cases the inclination of the head slider 8 cannot be obtained because of dimensional tolerance of parts associated with the securing portion. When the head slider 8 moves to a position above the magnetic disk 3 and it is inclined in the opposite direction (inclined forwards), proper lifting force cannot be obtained, and thus there is a risk that the air flow-in side of the head slider 8 will come into contact with the magnetic disk 3.

Therefore, in the head slider according to a first embodiment of the present invention, during the load operation, the surface shape of the head slider is set so that positive pressure acts on the air flow-in side and force acts on the air flow-in side so as to keep the air flow-in side displaced from the magnetic disk 3.

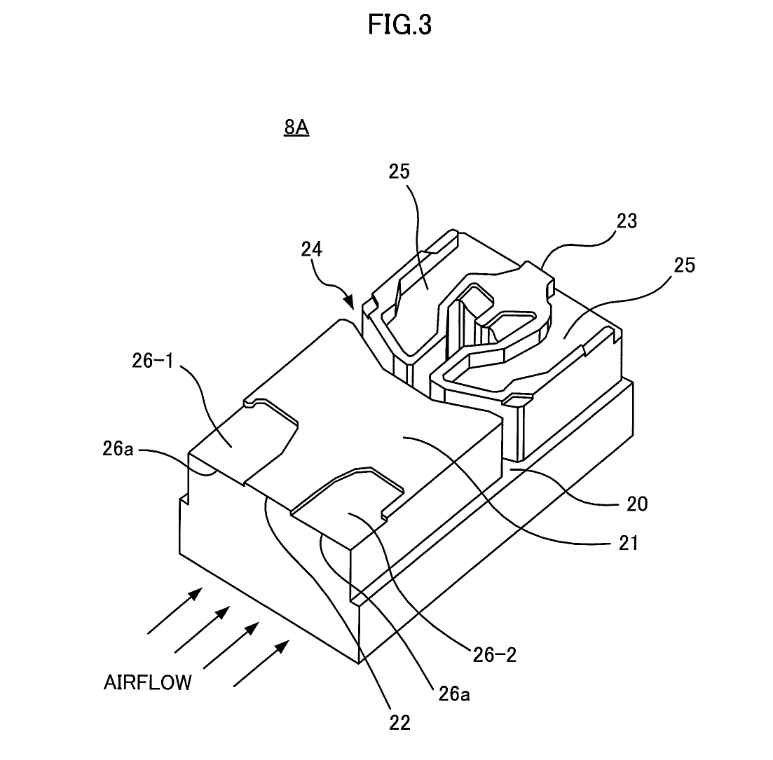

FIG. 3 is a perspective view showing a head slider 8A according to the first embodiment of the present invention. In FIG. 3, the surface of the head slider 8A which faces the magnetic disk 3 is placed face up. In this embodiment, the head slider 8A is designed in a rectangular shape of 0.7 mm in width and 1.25 mm in length. In FIG. 3, the dimension in the height direction is illustrated as being enlarged to show the shape thereof. The unevenness of the surface of the head slider 8A is actually the height (depth) of about several μm.

In FIG. 3, the face of the head slider 8A which faces the magnetic disk 3 contains a base face 20 as the lowest portion and a top face 21 as the highest portion. In this embodiment, the depth (distance) from the main top face 21 to the base face 20 is set to about 3 μm. Basically, the main top face 21 suffers static pressure and dynamical pressure of airflow to generate lifting force. Furthermore, a groove portion or recess portion which is deeply dug from the main top face 21 to the base face 20 generates negative pressure based on airflow. The head slider 8A is attracted to the magnetic disk device 3 by this negative pressure. Accordingly, the head slider 8A is prevented from being excessively far away from the magnetic disk 3 by excessive lifting force. Furthermore, a shallow recess portion intercommunicating with the main top face 21 generates positive pressure by airflow flowing from the shallow recess portion to the main top face 21.

In FIG. 3, the end portion at the lower right side of the main top face 21 is a front edge 22, and corresponds to the leading end of the head slider 8A with respect to the airflow. Accordingly, the opposite side to the leading end 22 is a trailing end 23 to which the airflow goes out from the head slider 8A. A deep groove or recess portion 24 extending to the base face 20 is formed substantially at the midpoint between the front edge 22 of the main top face 21 and the trailing end 23. A magnetic head (not shown) is provided in the neighborhood of the trailing end 23 and at the rear side of the recess portion 24. A negative pressure generating recess portion 25 is formed around a portion at which the magnetic head is provided. This embodiment is associated with the shape of the front side of the recess portion 24, and the detailed description on the rear side portion of the recess portion 24 is omitted.

In this embodiment, step faces 26-1 and 26-2 are formed at the right and left portions of the main top face 21 at the front side of the recess portion 24. The front edges 26a of the right and left step faces 26-1, 26-2 form the leading end of the head slider 8A, and extend to the trailing end of the head slider 8A. Accordingly, the front edge 22 of the main top face 21 and the front edges 26a of the right and left step faces 26-1 and 26-2 correspond to the leading end of the head slider 8A. In this embodiment, the step faces 26-1, 26-2 are surfaces which drop from the main top face 21 by about 0.1 μm. The main top face 21 remains between the right and left step faces 26-1, 26-2. The width thereof is preferably equal to about a quarter of the width of the head slider 8A. The step faces 26-1, 26-2 are provided to generate positive pressure at the rear side thereof.

That is, the gap between the head slider 8A and the magnetic disk 3 is smaller at the main top face 21 than the step faces 26-1, 26-2 (in this embodiment, the gap is smaller by the amount corresponding to only 0.1 μm which is the depth of the step face). Air pressure at the rear side of the step faces 26-1, 26-2 increases to generate positive pressure. This positive pressure is reduced when the gap between the head slider 8A and the magnetic disk 3 is larger, and it is increased as the gap is reduced. Accordingly, no large positive pressure occurs when the head slider 8A is floated under a stable state. For example, the positive pressure is increased if the head slider 8A moves downwardly to the surface of the magnetic disk 3 in the loading operation of the head slider 8A so that the gap is smaller than usual. In such a case, the downward movement of the front side portion of the head slider 8A can be efficiently suppressed.

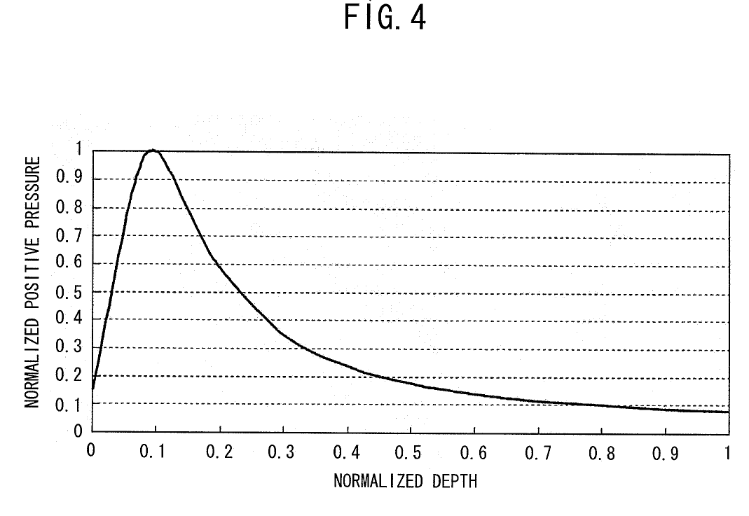

FIG. 4 is a graph showing the relationship between the depth of the step face and the occurring positive pressure. The abscissa axis represents the normalized depth of the step faces. The normalized depth is a dimensionless number obtained by dividing the depth by a predetermined depth. This is because the relationship between the depth of the step faces and the occurring positive pressure varies in accordance with the size, etc. of the head slider. The ordinate axis represents the normalized magnitude of the positive pressure. That is, the maximum value of the occurring positive pressure is set to 1, and the normalized magnitude represents the rate of the positive pressure to the maximum value.

The depth of the step faces 26-1, 26-2 from the top face 21 can be determined to be equal to a proper value from the graph shown in FIG. 4. For example, when the positive pressure is required to be increased, 0.1 is adopted as the normalized depth so that the positive pressure is maximum. In this embodiment, when the normalized depth is equal to 1, it represents 5 μm (that is, the value obtained by dividing the actual depth by 5 μm is set as the normalized depth). By setting the step faces 26-1, 26-2 to 0.5 μm, the substantially maximum positive pressure can be obtained. The head slider 8A shown in FIG. 3 is designed so that the depth of the step faces 26-1, 26-2 from the main top face 21 is set to 0.1 μm and the positive pressure at the normalized depth of 0.02 can be obtained.

At the portion where the step faces 26-1, 26-2 are provided, the volume at the gap between the head slider 8A and the magnetic disk 3 is larger as compared with a case where the step faces 26-1, 26-2 are not provided. When the head slider 8A descends to the magnetic disk 3, positive pressure occurs in accordance with the resistance of air when air in the space between the head slider 8A and the magnetic disk 3 is discharged. The action generated by the positive pressure when air is discharged from some space is generally referred to as a squeeze effect. The squeeze effect is larger as the volume of the space from which air is discharged increases. This embodiment utilizes the squeeze effect at the portion where the step faces 26-1, 26-2 are provided which is larger than the squeeze effect when the step faces 26-1, 26-2 are not provided. That is, when the front side of the head slider 8A moves to the magnetic disk 3, the movement concerned can be suppressed. For example, the squeeze effect is increased if the head slider 8A swiftly descends to the surface of the magnetic disk 3 in the load operation of the head slider 8A. The downward movement of the front side portion of the head slider 8A can be efficiently suppressed.

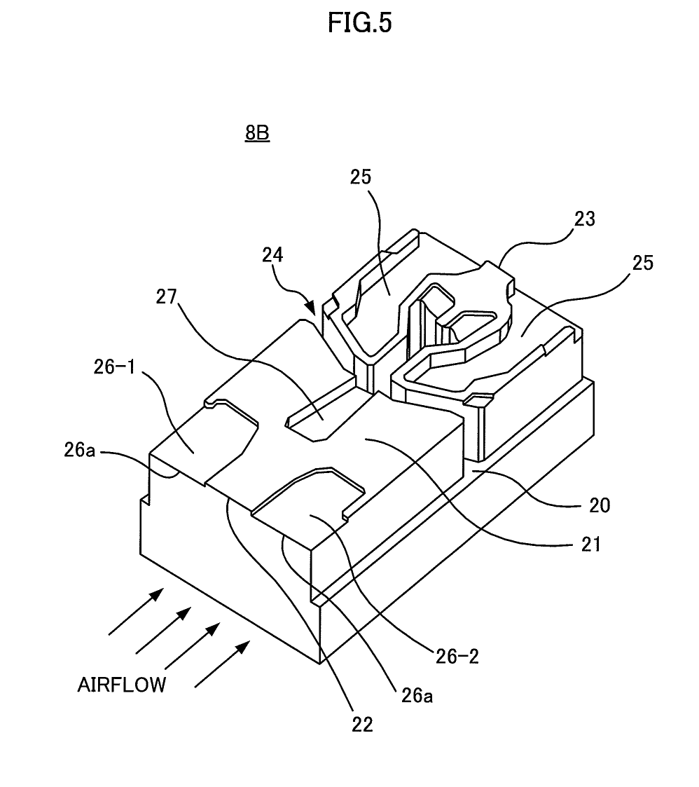

FIG. 5 is a perspective view showing a head slider 8B according to a modification of the head slider 8A shown in FIG. 3. In FIG. 5, the same parts as the constituent parts shown in FIG. 3 are represented by the same reference numerals, and the description thereof is omitted.

The head slider 8B shown in FIG. 5 has the same construction as the head slider 8A shown in FIG. 3 except that a negative pressure occurring face 27 is formed in the neighborhood of the center of the main top face 21. The negative pressure occurring face 27 corresponds to the bottom surface of a recess portion for generating negative pressure by airflow passing therethrough. The attitude of the head slider 8B when it is floated can be stabilized by the negative pressure occurring at the negative pressure occurring face 27. In this embodiment, the depth of the negative pressure occurring face 27 is set to 1 μm, and it is remarkably deeper than the depth (0.1 μm) of the step faces 26-1, 26-2.

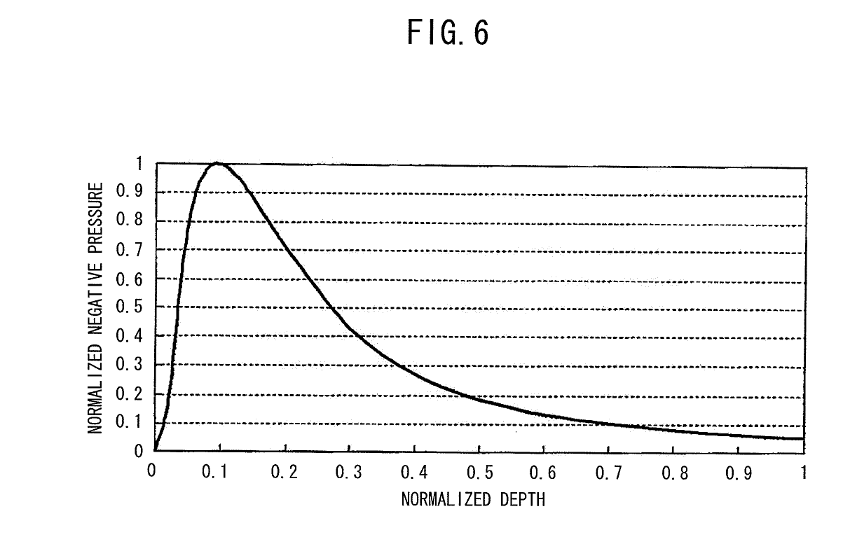

FIG. 6 is a graph showing the relationship between the depth of the negative pressure occurring face and the negative pressure. Like the graph shown in FIG. 4, the abscissa axis represents the normalized depth, and the ordinate axis represents the normalized value of the negative pressure. The depth which can generate proper negative pressure is determined on the basis of the graph shown in FIG. 6. In the case of this embodiment, the depth of the negative pressure occurring face is equal to 1 μm, and thus 0.2 which corresponds to the value obtained by dividing 0.1 μm by 5 μm corresponds to the depth of the negative pressure occurring face 27 in this embodiment. The negative pressure at the normalized depth (0.2) of the negative pressure occurring face is equal to about 0.7 of the maximum value. The curved line greatly varies in the neighborhood of the peak value as the maximum value. That means that when the depth varies slightly, the occurring negative pressure greatly varies. Accordingly, by using the depth in the neighborhood of the maximum value, the negative pressure may be greatly deviated from desired negative pressure depending on the processing error of the depth. In order to avoid the problem as described above, according to this embodiment, 0.2 is adopted because some degree of large negative pressure is obtained and also the gradient of the curved line is relatively gentle at that point. It is preferable to set the depth of the base face 20 from the main top face 21 so that the negative pressure is equal to the half of the maximum value or less. In this embodiment, the depth of the base face 20 is equal to 3 μm, and thus the normalized depth corresponds to 0.6. The standardized value of the negative pressure at that time is equal to about 0.12.

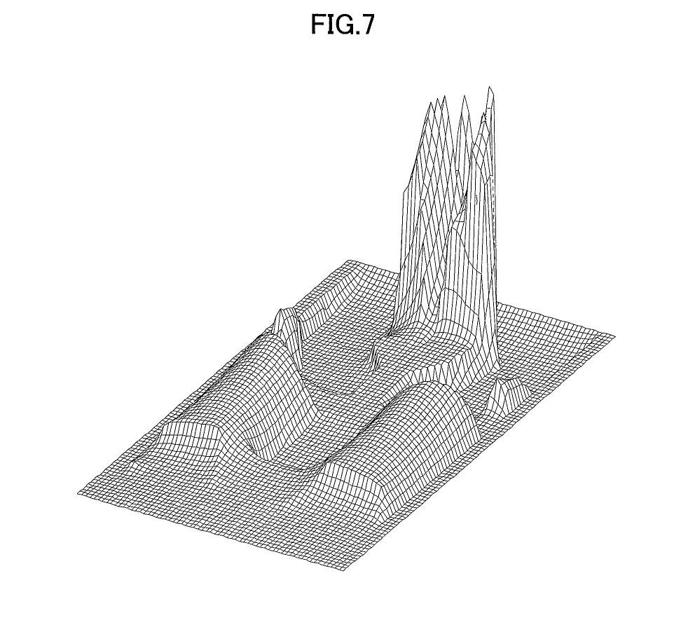

FIG. 7 is a diagram showing a computer simulation result of a pressure distribution in the head slider 8B. A deep color portion represents negative pressure, and a light color portion which is lifted up from the surrounding represents positive pressure. From FIG. 7, positive pressure occurs at the top face 21 behind the right and left step faces 26-1, 26-2. Negative pressure occurs at the negative pressure occurring face 27 between the portions at which the positive pressure occurs.

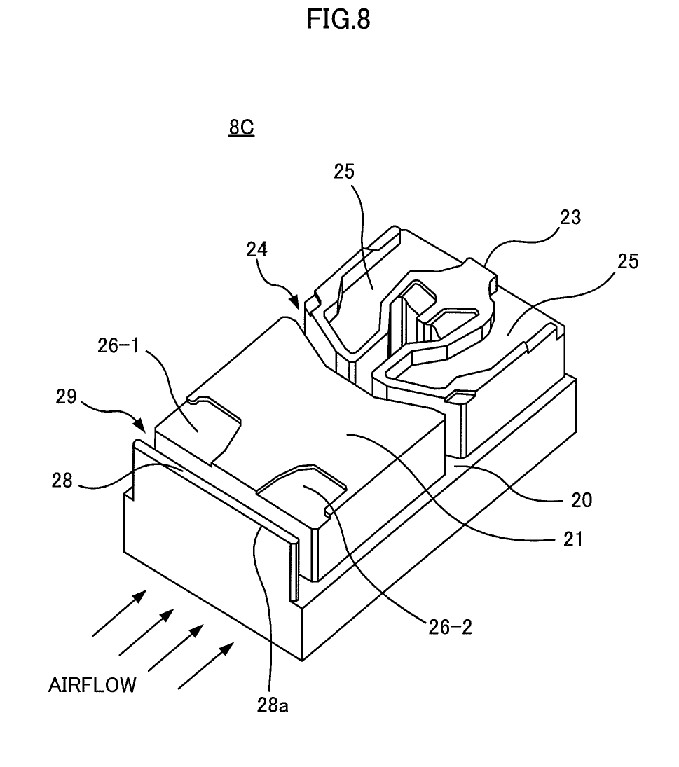

Next, the head slider according to a second embodiment of the present invention will be described with reference to FIG. 8. FIG. 8 is a perspective view showing a head slider 8C according to the second embodiment of the present invention. In FIG. 8, the same parts as the constituent parts shown in FIG. 3 are represented by the same reference numerals. In FIG. 8, the surface of the head slider 8C which faces the magnetic disk 3 is placed face up.

The head slider 8C shown in FIG. 8 basically has the same construction as the head slider 8A shown in FIG. 3. However, it is different in that a front side top face 28 is provided at the front side of the main top face 21 and the step faces 26-1, 26-2. The front side top face 28 extends in the same plane as the top face 21.

An gap having a predetermined width is provided between the front side top face 28 and each of the main top face 21 and the step faces 26-1, 26-2. Accordingly, the head slider 8A shown in FIG. 3 is constructed so that the portion at which the front side top face 28 is formed is provided at the front side of the portion at which the main top face is formed (at the upstream side of the airflow). However, when the overall dimension of the head slider 8C is set to be equal to the overall dimension of the head slider 8A, the main top face 21 and the step faces 26-1, 26-2 of the head slider 8C are deformed so that the top face 21 and the step faces 26-1, 26-2 of the head slider 8A are shortened in the front-and-back direction (the direction of airflow).

The portion at which the front side top face 28 is formed is erected from the base face 20. A deep groove or recess portion 29 is formed between the front side top face 28 and each of the main top face 21 and the step faces 26-1, 26-2. This recess portion 29 forms the gap of the predetermined width as described above, and it is provided to prevent air flowing along the front side top face 28 from directly flowing to the step faces 26-1, 26-2 which are provided behind the front side top face 28 so as to extend backwardly. If the recess portion 29 is not provided, air flowing along the front side top face 28 directly flows to the step faces 26-1, 26-2 having steps. Therefore, negative pressure occurs at the step faces 26-1, 26-2. When the relatively deep recess portion 29 exists between the front side top face 28a and the step faces 26-1, 26-2, air which flows along the front side top face 28 and enters the recess portion 29 temporarily has negative pressure, and then the pressure thereof is returned to the proximity of the atmospheric pressure. Then, the air flows into the step faces 26-1, 26-2. Accordingly, occurrence of negative pressure at the step faces 26-1, 26-2 is suppressed. Furthermore, proper positive pressure can be generated at the main top face 21 at the rear side of the step faces 26-1, 26-2.

In this embodiment, the bottom portion of the recess portion 29 is in the same plane as the base face 20. However, the depth of the recess portion 29 may be set to be deeper or shallower than the depth of the base face 20 so that the pressure of the air is returned to the proximity of the atmospheric pressure. In this embodiment, the recess portion 29 is formed simultaneously with the processing of the base face 20, and thus the bottom surface of the recess portion and the base face 20 are processed to be in the same plane.

As described above, according to this embodiment, the front side top face 28, which is located at the same height as the main top face 21 but is located at a higher position than the step faces 26-1, 26-2, is formed at the front side of the step faces 26-1, 26-2. The portion at which the front side top face 28 is formed corresponds to the forefront portion of the head slider 8C, and it acts as a so-called bumper which splashes dust when the dust impinges against the head slider 8C due to the airflow. In this embodiment, the thickness of the portion at which the front side top face 28 is formed is equal to 20 to 30 μm, and it is the minimum dimension for processing purposes. Furthermore, the front side top face 28 is provided at the front side of the main top face 21 and the step faces 26-1, 26-2. Accordingly, the front edge 28a of the front side top face 28 corresponds to the leading end of the head slider 8C.

When the head slider 8C is floated above the magnetic disk 3, the distance from the front edge of the head slider 8C to the surface of the magnetic disk 3 corresponds to the distance from the front edge of the front side top face 28 to the surface of the magnetic disk 3. On the other hand, when the front side top face 28 is not provided, the front edges of the step faces 26-1, 26-2 correspond to the front edge of the head slider 8C. Accordingly, the distance from the front edge of the head slider 8C to the magnetic disk is larger than the distance when the front side top face 28 exists. In other words, by providing the front side top face 28, the distance between the front edge of the head slider 8C and the surface of the magnetic disk 3 can be reduced. Accordingly, even if dust in the airflow enters the gap between the head slider 8C and the magnetic disk 3, the size of the dust is reduced by the amount corresponding to the provision of the front side top face 28. Accordingly, large dust can be prevented from being stuck in the gap between the head slider 8C and the magnetic disk 3. Furthermore, the surface of the head slider 8C and the surface of the magnetic disk 3 can be prevented from being damaged.

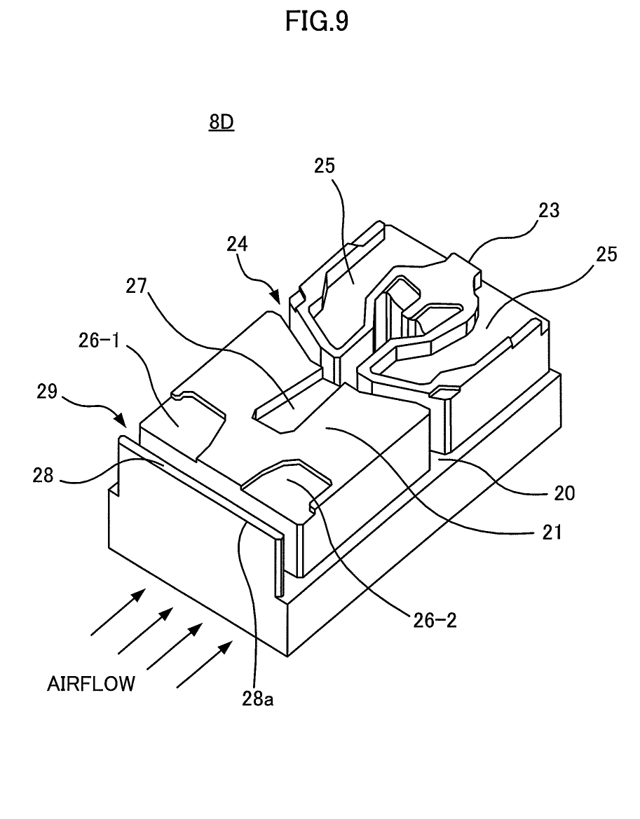

FIG. 9 is a perspective view of the head slider 8D according to a modification of the head slider 8C shown in FIG. 8. In FIG. 9, the same parts as constituent parts shown in FIG. 8 are represented by the same reference numerals.

The head slider 8D shown in FIG. 9 has substantially the same construction as the head slider 8C shown in FIG. 9. However, it is different in that the negative pressure occurring pressure 27 is formed in the neighborhood of the center of the main top face 21. The negative pressure occurring face 27 corresponds to the bottom surface of the recess portion for generating negative pressure by airflow passing over the negative pressure occurring face 27. The attitude of the head slider 8D under the floating state can be stabilized by the negative pressure occurring at the negative pressure occurring face 27. In this embodiment, the depth of the negative pressure occurring face 27 is set to 1 μm.

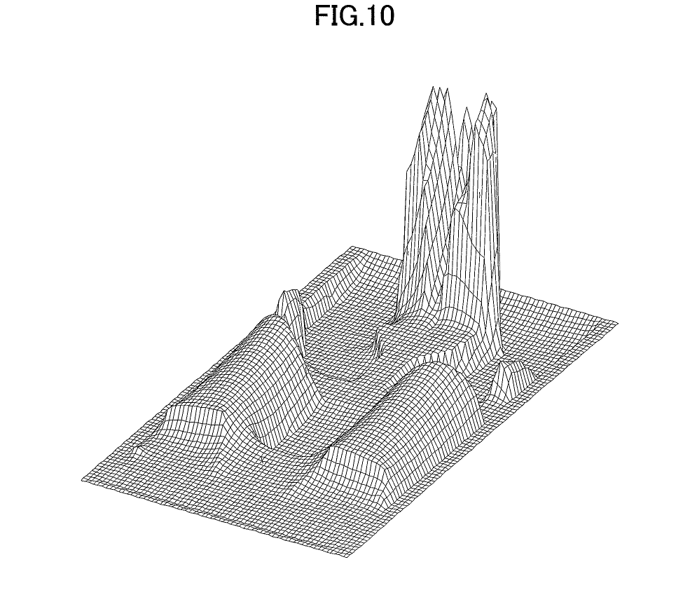

FIG. 10 is a diagram showing a computer simulation result of a pressure distribution of the head slider 8D. A deep color portion represents the negative pressure. A light color portion which is lifted up from the surrounding represents the positive pressure. From FIG. 10, positive pressure occurs at the top face 21 at the rear side of right and left step faces 26-1, 26-2. Negative pressure occurs at the portion of the negative pressure occurring face 27 between the portions at which positive pressure occurs.

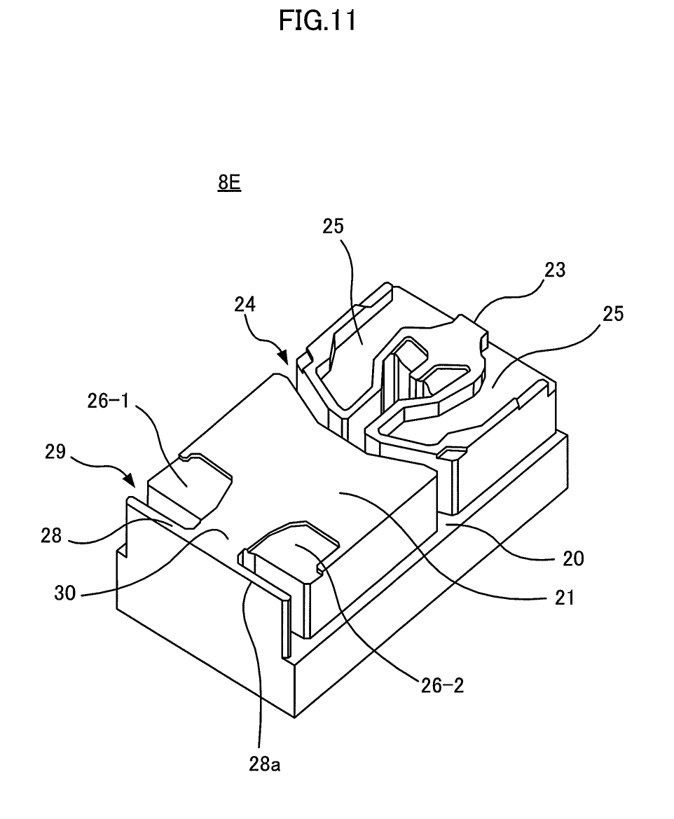

Next, a head slider according to a third embodiment of the present invention will be described with reference to FIG. 11. FIG. 11 is a perspective view showing a head slider 8E according to a third embodiment of the present invention. In FIG. 8, the same parts as the constituent parts shown in FIG. 8 are represented by the same reference numerals. In FIG. 11, the surface of the head slider 8E which faces the magnetic disk 3 is placed face up.

The head slider 8E shown in FIG. 11 basically has the same construction as the head slider 8A shown in FIG. 8. A front side top face 28 is provided at the front side of the main top face 21 and the step faces 26-1, 26-2. However, it is different in that the front side top face and the main top face 21 are connected to each other through a connection top face 30. The connection top face 30 is provided so as to extend in the same plane as the front side top face 28 and the main top face 21. That is, the connection top face 30, the front side top face 28 and the main top face 21 constitute a continuous plane.

By providing the connection top face 30, the portion at which the connection top face 30 is formed is provided at the front side of the front edge 22 of the main top face 21 at the center of the recess portion 29. Accordingly, the recess portion 29 is segmented by the portion at which the connection top face 30 is formed. In other words, the portion at which the main top face 21 is formed and the portion at which the front side top face 28 is formed are connected to each other by the portion at which the connection top face 30 is formed.

It is preferable that the thickness of the portion at which the front side top face 28 is formed to be as small as possible. However, if the thickness is excessively small, the strength of the portion at which the front side top face 28 is formed is insufficient. Therefore, according to this embodiment, by providing the portion at which the connection top face 30 is formed, the center portion of the portion at which the front side top face 28 is formed is integrated with the portion at which the main top face 21 is formed, thereby enhancing the strength.

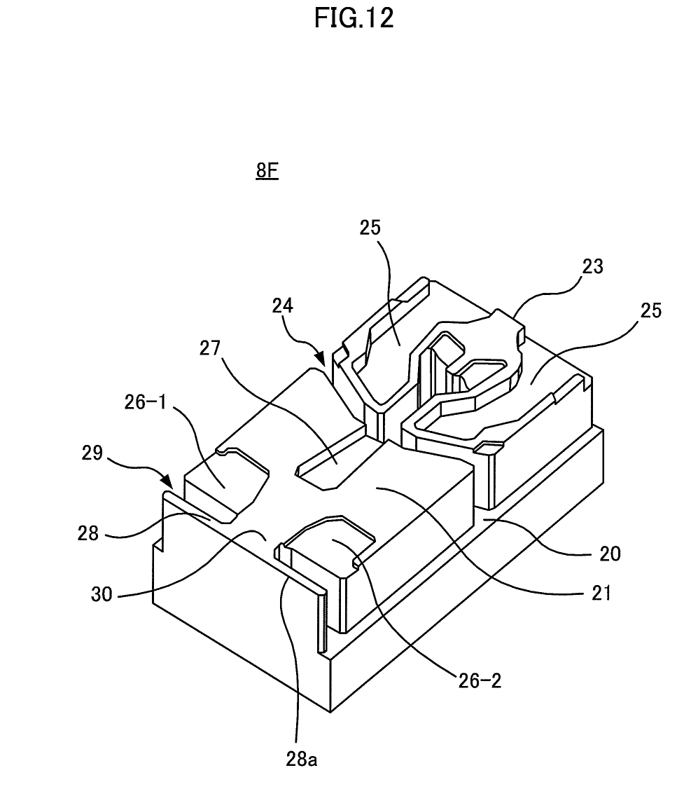

FIG. 12 is a perspective view showing a head slider 8F according to a modification of the head slider 8E shown in FIG. 11. In FIG. 12, the constituent parts shown in FIG. 11 are represented by the same reference numerals.

The head slider 8F shown in FIG. 12 has substantially the same construction as the head slider 8E shown in FIG. 12. However, it is different in that the negative pressure occurring face 27 is formed in the neighborhood of the main top face 21. The negative pressure occurring face 27 corresponds to the bottom surface of the recess portion for generating negative pressure by airflow passing over the negative pressure occurring face 27. The attitude of the head slider 8F under the floating state can be stabilized by the negative pressure occurring at the negative pressure occurring face 27. In this embodiment, the depth of the negative pressure occurring face 27 is set to 1 μm.

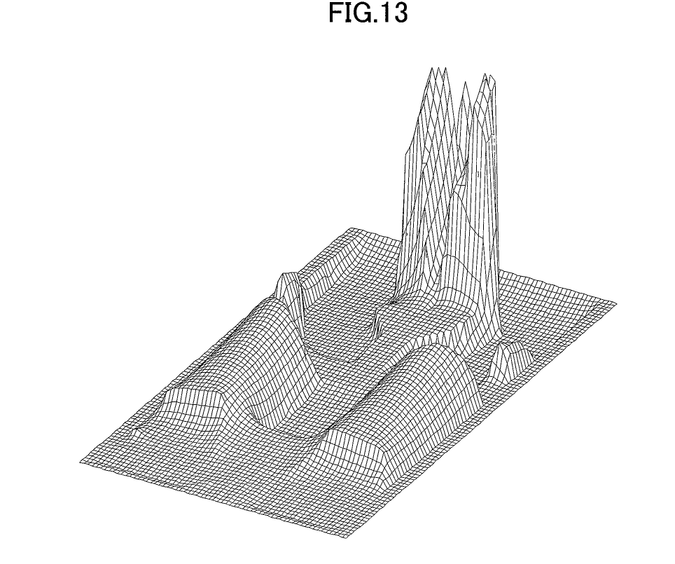

FIG. 13 is a computer simulation result of a pressure distribution in the head slider 8E. A deep color portion represents the negative pressure. A light color portion which is lifted up from the surrounding thereof represents the positive pressure. In FIG. 13, positive pressure occurs at the top face 21 behind the right and left step faces 26-1, 26-2. Negative pressure occurs at the portion of the negative pressure occurring face 27 between the portions at which the positive pressure occurs.

In this embodiment, the magnetic head slider is described as an example. However, the present invention is not limited to the magnetic head slider, and it may be a slider having an optical head or a magnetooptical head mounted thereon.

According to the present invention, there can be provided a head slider that hardly comes into contact with a recording medium by utilizing positive pressure based on the top face and the squeeze effect during the load operation.

Although the embodiments of the present inventions have been described in detail, it should be understood that the various changes, substitutions, and alterations could be made hereto without departing from the spirit and scope of the invention.

What is claimed is:

1. A head slider having a leading end and a trailing end of airflow occurring in connection with movement of a moving recording medium when the head slider is disposed above the recording medium, comprising:
a main top face that is configured to face the recording medium and forms a part of the leading end; and
two step faces that extend from the leading end to a downstream side at a lower position than the main top face when the main top face is placed face up,
wherein the step faces are respectively provided at the right and left sides with respect to the airflow,
a part of said main top face is provided so as to extend between said two step faces, and
the other portion of said main top face is provided so as to extend at the rear side of the said step faces, at least a part of the head slider being floated above the recording medium.

2. The head slider according to claim 1, further comprising a front side top face provided at the front side of said main top face and said step faces,
wherein said front side top face extends in the same plane as said main top face.

3. The head slider according to claim 2, further comprising a recess portion having a predetermined depth provided between said front side top face and each of said main top face and said step faces.

4. The head slider according to claim 1, further comprising a base face that is lower than said main top face by a predetermined distance; and
a front side top face that is provided at the front side of said main top face and said step faces,
wherein the height of said front side top face from said base face is equal to the height of said main top face from said base face.

5. The head slider according to claim 4, wherein said step faces are disposed between said base face and said main top face in the height direction from said base face.

6. The head slider according to claim 4, wherein said base face and the bottom surface of said recess portion extend in the same plane.

7. The head slider according to claim 4, wherein the predetermined distance of said base face from said main top face is set so that the negative pressure occurring by airflow flowing from said main top face to said base face is equal to or less than the half of the maximum value.

8. The head slider according to claim 3, further comprising a connection top face provided between said front side top face and said main top face,
wherein said connection top face extends in the same plane as said main top face and said front side top face, and
said front side top face, said connection top face and said main top face constitute a continuous plane.

9. The head slider according to claims 1, further comprising a recess portion provided in a portion between areas of said main top face at the rear side of said two step faces,
wherein the bottom surface of the recess portion is a negative pressure occurring face.

10. The head slider according to claims 2, further comprising a recess portion provided in a portion between areas of said main top face at the rear side of said two step faces,
wherein the bottom surface of the recess portion is a negative pressure occurring face.

11. The head slider according to claims 4, further comprising a recess portion provided in a portion between areas of said main top face at the rear side of said two step faces,
wherein the bottom surface of the recess portion is a negative pressure occurring face.

12. The head slider according to claim 1, wherein the negative pressure occurring face extends at a lower position than the step faces.

13. The head slider according to claim 2, wherein the negative pressure occurring face extends at a lower position than the step faces.

14. The head slider according to claim 4, wherein the negative pressure occurring face extends at a lower position than the step faces.

15. A head assembly, comprising:
a head slider having a leading end and a trailing end of airflow occurring in connection with movement of a moving recording medium when the head slider is disposed above the recording medium, comprising:
a main top face that is configured to face the recording medium and forms a part of the leading end; and
two step faces that extend from the leading end to a downstream side at a lower position than the main top face when the main top face is placed face up,
wherein the step faces are respectively provided at the right and left sides with respect to the airflow,
a part of said main top face is provided so as to extend between said two step faces,
the other portion of said main top face is provided so as to extend at the rear side of the said step faces, and
at least a part of the head slider being floated above the recording medium; and
a head suspension attached to said head slider, having a flexibility.

16. The head assembly according to claim 15, wherein said head slider further comprises a front side top face provided at the front side of said main top face and said step faces, and
said front side top face extends in the same plane as said main top face.

17. The head assembly according to claim 15, wherein said head slider further comprises a base face that is lower than said main top face by a predetermined distance; and
a front side top face is provided at the front side of said main top face and said step faces, and
the height of said front side top face from said base face is equal to the height of said main top face from said base face.

18. A storage apparatus, comprising:
a head slider having a leading end and a trailing end of airflow occurring in connection with movement of a moving recording medium when the head slider is disposed above the recording medium, comprising:
a main top face that is configured to face the recording medium and forms a part of the leading end; and
two step faces that extend from the leading end to a downstream side at a lower position than the main top face when the main top face is oriented face up,
wherein the step faces are respectively provided at the right and left sides with respect to the airflow,
a part of said main top face is provided so as to extend between said two step faces, and
the other portion of said main top face is provided so as to extend at the rear side of the said step faces,
at least a part of the head slider being floated above the recording medium;
a head suspension attached to said head slider, having a flexibility; and
an actuator arm fixing an end of said suspension, flexibly pivoting.

19. The storage apparatus according to claim 18, wherein said head slider further comprises a front side top face provided at the front side of said main top face and said step faces, and
said front side top face extends in the same plane as said main top face.

20. The storage apparatus according to claim 18, wherein said head slider further comprises a base face that is lower than said main top face by a predetermined distance; and
a front side top face is provided at the front side of said main top face and said step faces, and
the height of said front side top face from said base face is equal to the height of said main top face from said base face.
